(19) United States
(12) Patent Application Publication
(10) Pub. No.: US 2011/0180565 A1
(43) Pub. Date: Jul. 28, 2011

(54) Method and Apparatus for Dispensing Product

(75) Inventors: David Racino, Austin, TX (US); Michael Daniel, Austin, TX (US); Jeffrey Van Myers, Driftwood, TX (US); Artie Pennington, Austin, TX (US)

(73) Assignee: FALCON TAPS, LLC, Austin, TX (US)

(21) Appl. No.: 13/012,006

(22) Filed: Jan. 24, 2011

Related U.S. Application Data
(60) Provisional application No. 61/297,750, filed on Jan. 23, 2010.

(51) Int. Cl. B67D 1/08

(52) U.S. Cl. 222/61

(57) ABSTRACT

A portable carbonated liquid dispensing system, with an adjustable, internal pressure regulating system. The complexity of the dispensing system is adaptable. In its simplest form, the system accepts a single user entered pressure setting, and utilizes system feedback to maintain pressure within a predetermined range of the selected setting. In its most complete form, pressure, flow rate and temperature feedback and control systems allow fluid to be dispensed under conditions selected via user input data regarding the type of liquid being dispensed, taking into consideration optimal pressure, flow rate and temperature relationships as determined by the manufacturer of the fluid.

### BACKGROUND OF THE INVENTION

1. Field of the Invention

The present invention relates generally to an electronically controlled, carbonated liquid dispensing system, and, in particular, to a dispensing system adapted selectively to band-limit carbonation pressure and dispensing flow rate.

2. Description of the Related Art

In general, in the descriptions that follow, we will italicize the first occurrence of each special term of art that should be familiar to those skilled in the art of carbonated liquid product dispensing systems. In addition, when we first introduce a term that we believe to be new or that we will use in a context that we believe to be new, we will bold the term and provide the definition that we intend to apply to that term.

In a typical commercial beer brewing operation, the wort is allowed to ferment until a desired level of ethyl alcohol is achieved. For some types of beer, fermentation is allowed to continue until the alcohol level becomes toxic to the yeast, at which point fermentation will cease naturally. For other types, fermentation is terminated prematurely by artificial means, such as heat, when a specific level of alcohol is achieved or a desired level of residual sugar remains. Following termination of fermentation, most commercial breweries filter the flat beer to remove all particulates, especially the yeast bodies. Often, the beer is then sterilized, using, e.g., strong ultraviolet light, to kill any residual yeast plants. Finally, the bulk beer will be carbonated using a primary source of pressurized carbon dioxide (“CO₂”), and transferred into stainless steel or aluminum kegs for storage and subsequent transport to the consumer. In some so-called micro-breweries, the alcohol and residual sugar levels of the wort are carefully monitored, and, at a desired point prior to termination of fermentation, the wort is racked directly into kegs, and allowed to carbonate in situ as a result of the exhalation of CO₂ by the yeast until fermentation terminates naturally.

At the point of consumption, the keg is tapped using a suitable dispensing apparatus. Usually, this dispenser consists of a coupler suitable for the type of keg, and either a flexible hose or rigid tube terminating at a manually-operated spigot. Initially, the internal pressure is sufficient to force the beer through the dispensing system; as the pressure drops, supplemental pressure is often provided via a hand-operated air pump. As is known, the use of ambient air for supplemental pressurization is undesirable because the oxygen (“O₂”) component of the air tends to degrade the beer; thus, if the beer in the keg is only partially consumed, the remaining quantity will often be discarded. One example of such a dispenser is shown in Brown, U.S. Pat. No. 4,711,377, expressly incorporated herein by reference (“Brown”). A somewhat more sophisticated dispenser having an electrically-operated air pump is shown in Tieskoetter, U.S. Pat. No. 5,785,211, expressly incorporated herein by reference (“Tieskoetter”).

Alternatively, the pressure in the keg is maintained using a supplemental tank of pressurized CO₂. One early example of a CO₂ dispenser is shown in Fine, et al., U.S. Pat. No. 2,571,433, expressly incorporated herein by reference (“Fine”). Another more recent example is shown in Zurit, et al., U.S. Pat. No. 4,180,189, (“Zurit”), expressly incorporated herein by reference. An example of a portable back-pack dispensing system is shown in Ash, U.S. Pat. No. 5,199,609, expressly incorporated herein by reference (“Ash”). One other example is shown in Hammond, U.S. Pat. No. 7,131,560, expressly incorporated herein by reference (“Hammond”).

As is known, beer is made from only four basic ingredients: water, malted barley, yeast and a bittering agent, typically the dried flowers of certain varieties of the hops plant, i.e., bittering hops. Some recipes require additional adjuncts, i.e., unmalted grains, and any of a number of flavoring/aromatic agents, e.g., aromatic hops, selected herbs and/or spices. In general, the species of yeast determines the type of beer: bottom fermenting yeast produces ale; whereas top fermenting yeast produces lager. Ale is typically brewed at temperatures well above freezing, and tends to be suitable for consumption within a few days following initiation of fermentation (after one or more racking steps). In contrast, lager is typically brewed at significantly lower temperatures, and then, after final racking, stored at temperature slightly above freezing for 3-6 (or more) weeks following completion of fermentation (the German word “lager” means “to store”). Further details about the brewing process can be found in The Brew-Master's Bible by S. Snyder, HarperPerennial (1997), expressly incorporated herein by reference (“Snyder”). A more hands-on approach can be found in The Complete Book of Home Brewing by D. Miller, Garden Way Publishing (1988), expressly incorporated herein by reference (“Miller”). Both Snyder and Miller appear to be readily available from, e.g., Amazon.com.

It is known that the optimal delivery conditions of a beer depend primarily on whether it is an ale or a lager. Ales are preferably maintained at carbonation levels below those normal for lagers. Ales are preferably dispensed at significantly warmer temperatures than are lagers. Ales are preferably dispensed at higher flow rates to encourage the development of significant heads of foam; lagers are preferably dispensed at lower flow rates to discourage the development of significant heads. However, each brewmaster is (or, as we believe, should be) free to decide, for each of her styles, what these optimum conditions will be, and, to some extent, to craft the formulation and brewing process for each style to benefit maximally from those conditions. Unfortunately, unless the brewmaster has direct control over the dispensing system equipment, as might be the case for a pub co-located with a micro-brewery, this goal is currently unattainable given the present state of the art in commercial beer dispensing systems.

In all of the portable CO₂-based dispensers known to us, the pressure maintained in the keg is only crudely controlled via a manually-adjusted, mechanical pressure regulator (see, e.g., Hammond). In such an arrangement, a decrease in the temperature of the fluid in the keg will result in a drop in pressure and a concomitant injection of additional supplemental gas; a subsequent increase in temperature will result in an increase in pressure without a suitable release of gas. Simple mechanical over-pressure relieve valves, as in Tieskoetter, are designed to prevent rupture of the keg, and are generally insufficient to prevent over-pressurization of the beer, especially low-carbonation ales and the like.

One other deficiency in known dispensers is the crude control provided for the rate of delivery of the beer. In particular, simple manually-operated spigots vary widely as to rate of delivery, and, as a result, the beer is often delivered at a rate that results in excessive foaming. This is further exacerbated as consumers, generally ignorant of the optimal flow rate, will usually be more interested in quick delivery than in quality delivery.

We submit that what is desired is a dispensing system that selectively controls, automatically, both the internal pressure and the delivery rate based on real-time conditions within the tank. Preferably, the dispenser should be capable of varying both keg pressure and delivery flow rate in accordance with a set of operating band limits specific to the type of beer being dispensed. Further, the dispenser should be responsive to information provided by the consumer regarding the desired conditions of delivery.

### BRIEF SUMMARY OF THE INVENTION

In accordance with a preferred embodiment of our invention, we provide a carbonated liquid dispensing system comprising a compressed CO₂ gas container and a fluid container that holds the carbonated fluid to be dispensed. The system has a user interface that enables a user to select a pressure range and a flow rate range. The system also has a gas delivery subsystem that delivers gas from the gas container to the fluid container at a selected pressure. The system also has a fluid delivery subsystem that delivers fluid from the second container to an outlet at a selected flow rate. The system also has a controller that is responsive to the user interface and controls the gas delivery subsystem to constrain the selected pressure to within the selected pressure range. Additionally, the controller controls the fluid delivery subsystem to constrain the selected flow rate to within the selected flow rate range.

In accordance with another preferred embodiment of our invention, we provide a carbonated liquid dispensing system comprising a compressed CO₂ gas container and a fluid container that holds the carbonated fluid to be dispensed. The system has a user interface that enables a user to select a pressure range. The system also has a gas delivery subsystem that delivers gas from the gas container to the fluid container at a selected pressure. The system also has a controller that is responsive to the user interface and controls the gas delivery subsystem to constrain the selected pressure to within the selected pressure range.

In accordance with another preferred embodiment of our invention, we provide a carbonated liquid dispensing system comprising a compressed CO₂ gas container and a fluid container that holds the carbonated fluid to be dispensed. The system has a user interface that enables a user to select a pressure range and a flow rate range. The system also has a gas delivery subsystem that delivers gas from the gas container to the fluid container at a selected pressure. The system also has a fluid delivery subsystem that delivers fluid from the second container to an outlet at a selected flow rate. The system also has a temperature control subsystem that determines the temperature of the fluid delivered by the fluid delivery subsystem. The system also has a controller that is responsive to the user interface and controls the gas delivery subsystem to constrain the selected pressure to within the selected pressure range as a function of the determined temperature. Additionally, the controller controls the fluid delivery subsystem to constrain the selected flow rate to within the selected flow rate range as a function of the determined temperature.

In accordance with another preferred embodiment of our invention, we provide a carbonated liquid dispensing system comprising a compressed CO₂ gas container and a fluid container that holds the carbonated fluid to be dispensed. The system has a user interface that enables a user to select a pressure range. The system also has a gas delivery subsystem that delivers gas from the gas container to the fluid container at a selected pressure. The system also has a temperature control subsystem that determines the temperature of the fluid to be dispensed. The system also has a controller that is responsive to the user interface and controls the gas delivery subsystem to constrain the selected pressure to within the selected pressure range as a function of said determined temperature.

We submit that our invention provides a dispensing system that: selectively controls both the internal pressure and the delivery rate based on real-time conditions within the tank; varies both keg pressure and delivery rate in accordance with a set of operating band limits specific to the type of beer being dispensed; and is responsive to information provided by the consumer regarding the desired conditions of delivery.

### BRIEF DESCRIPTION OF THE SEVERAL VIEWS OF THE DRAWINGS

Our invention may be more fully understood by a description of certain preferred embodiments in conjunction with the attached drawings in which:

FIG. 1 illustrates in block diagram form a carbonated fluid dispensing system constructed in accordance with a preferred embodiment of our invention; and

FIG. 2, comprising FIG. 2a and FIG. 2b, illustrates two representative views, in partial cross-sectional perspective, of one embodiment of a dispenser constructed in accordance with the system of FIG. 1.

In the drawings, similar elements will be similarly numbered whenever possible. However, this practice is simply for convenience of reference and to avoid unnecessary proliferation of numbers, and is not intended to imply or suggest that our invention requires identity in either function or structure in the several embodiments.

### DETAILED DESCRIPTION OF THE INVENTION

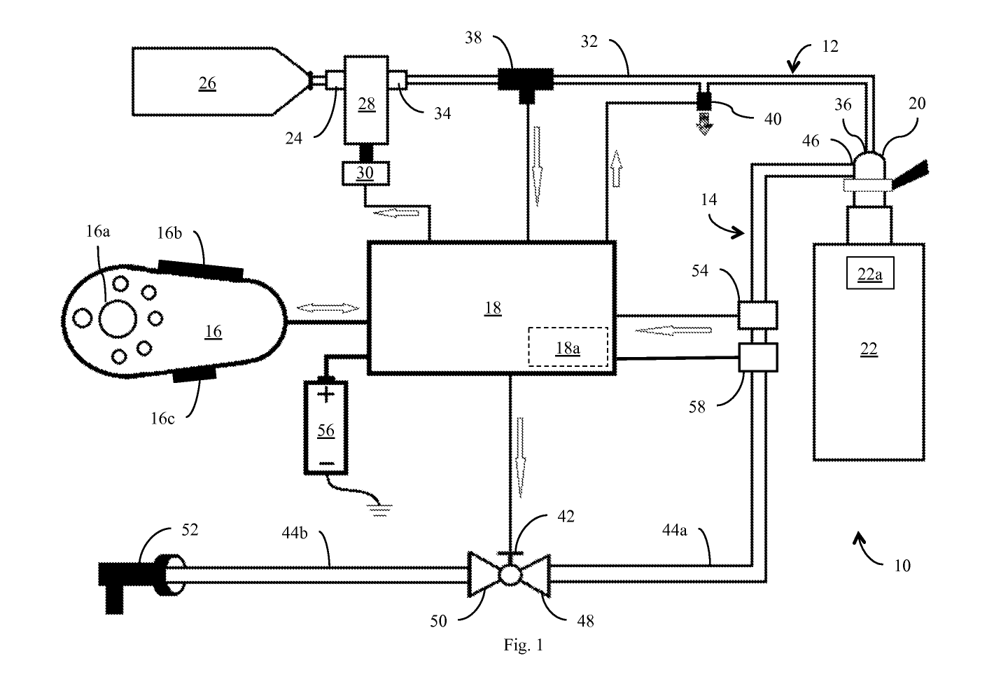

In accordance with the preferred embodiment of our invention, illustrated in FIG. 1, our dispensing system 10 generally comprises: a gas delivery subsystem 12; a fluid delivery subsystem 14; a user interface 16; and an electronic controller 18 adapted to selectively control, substantially simultaneously, the operation of the gas delivery subsystem 12 and the fluid delivery subsystem 14 in response to, and in accordance with, control information selected by a user via user interface 16. Our dispenser 10 further includes a coupler 20 adapted to be connected to a user-supplied keg 22, and a coupler 24 adapted to be connected to a user-supplied tank 26 containing compressed CO₂ gas.

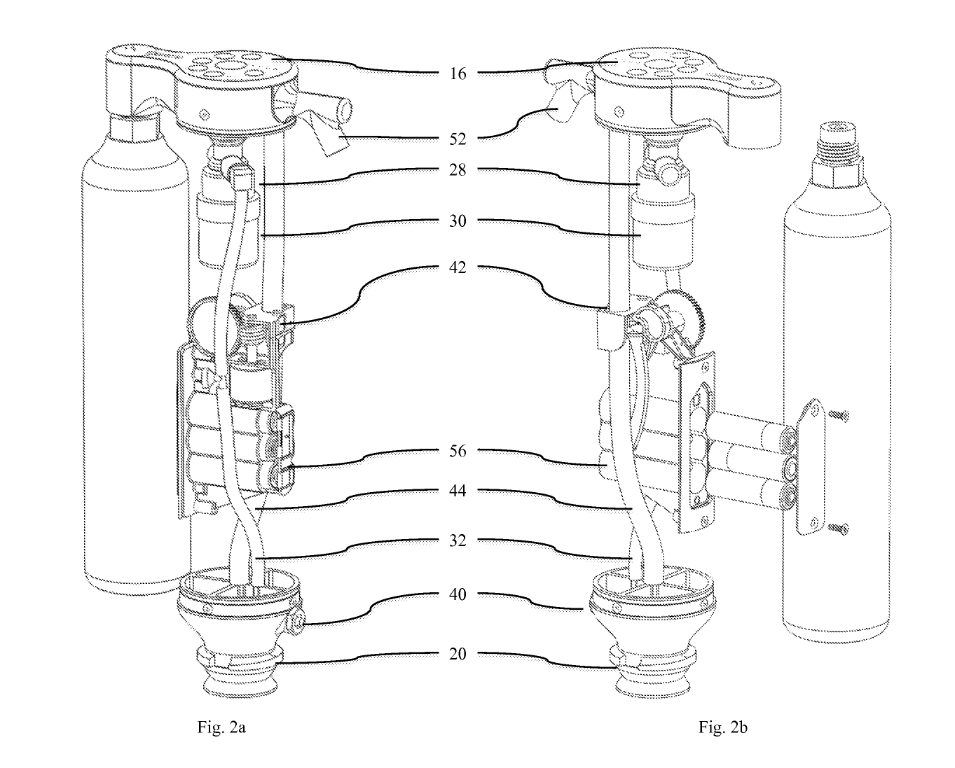

As shown in FIG. 1, our gas delivery subsystem 12 includes a single stage regulator 28 operable via an electrically-actuated servomotor 30. A gas delivery tube 32 connects a gas outlet port 34 of regulator 28 to a gas inlet port 36 of coupler 20 (see, FIG. 2). A pressure transducer 38 is connected to the gas delivery tube 32 to provide, during operation, electrical signals proportional to the gas pressure within gas delivery tube 32. An electrically-actuated pressure relief valve 40 is also connected to the gas delivery tube 32 to facilitate selective release of gas in the event of over pressurization within gas delivery tube 32. During normal operation, controller 18 selectively actuates servomotor 30 to increase the pressure of CO₂ gas in tube 32 until the pressure detected by transducer 38 is within a selected upper and lower band of operation. As will be discussed below, controller 18 is adapted to receive the operating pressure parameters via electronic means.

As also shown in FIG. 1, our fluid delivery subsystem 14 includes an electrically-actuated flow control valve 42. A primary fluid delivery tube 44a connects a fluid outlet port 46 of coupler 20 to a fluid inlet port 48 of valve 42 (see, FIG. 2), and a secondary fluid delivery tube 44b connects a fluid outlet port 50 of valve 42 to a fluid delivery spigot 52. In the illustrated embodiment, spigot 52 is a simple open port; the user signals a desire for fluid delivery by pressing an appropriate input element 16a of the user interface 16. A flow rate transducer 54 is connected to the primary fluid delivery tube 44a to provide, during operation, electrical signals proportional to the fluid flow rate within tube 44a. During normal operation, controller 18 selectively actuates valve 42 to increase the rate of flow of fluid through tube 44a until the flow rate detected by transducer 54 is within a selected upper and lower band of operation. As will be discussed below, controller 18 is adapted to receive the operating flow rate parameters via electronic means.

In accordance with our invention, controller 18 can be realized using any of a wide variety of integrated semiconductor microcontrollers; our microcontroller of choice is the MC9S08LG32 commercially available from Freescale Semiconductor, Inc. User interface 16 includes several input elements 16a which, when pressed by the user, will send respective control signals to controller 18. Including all electrically operated components within our dispenser 10, sufficient operating power can be obtained using, for example, 2-3 conventional 1.5 v batteries 56.

In one embodiment, controller 18 includes an array of conventional flash memory 18a adapted to store a plurality of sets of control tables, each set comprised of at least a pressure control table and a flow rate control table. Preferably, each table set comprises suitable pressure and flow rate parameters for a respective style of beer, e.g., ale or lager. In normal operation, the user actuates selected input elements 16a of the user interface 16 to indicate to controller 18 the type of beer being dispensed.

In one enhanced embodiment, memory 18a stores a plurality of control table sets for each type of beer, each set being assigned a respective access code. Based on information provided by the brewery, e.g., via a label 22a applied to keg 22 at the time of filling, the user may enter the applicable access code using the user interface 16, thereby achieving the delivery conditions intended by the brewmaster.

In one further enhanced embodiment, user interface 16 includes a card interface 16b adapted to accept a smart card carrier (not shown) or the like containing one or more supplemental sets of control tables. Upon insertion by the user, controller 18 downloads the control table(s) from the carrier, and, at the option of the user, uses such supplemental table(s) only for the current dispensing operation or adds such table(s) to the memory 18a for future access and use. In such an embodiment, the brewer can attach the carrier to the keg (or otherwise distribute the carrier to the user at the time of transfer), thereby enabling the user to adapt our dispenser 10 to achieve delivery conditions intended by the brewmaster.

In yet another enhanced embodiment, user interface 16 includes a USB interface 16c, or the like, adapted to facilitate electronic download of one or more supplemental sets of control tables by controller 18, for user-selected one-time or multiple-time access and usage. In one form, a flash-memory-based memory stick (not shown) or the like can be used to accomplish the transfer. Alternatively, download can be accomplished via the USB interface 16c using a conventional computing system, e.g., a personal computer, personal digital assistant, smart phone or the like. Of course, other facilities may be employed for downloading supplemental control tables, including any of a number of wired or wireless communication technologies known today or developed hereafter. In all such embodiments, however, the goal is to make available to our controller 18 the pressure and flow rate parameters most suitable for the type and style of beer being dispensed.

In yet another enhanced embodiment, a temperature transducer 58 is connected to the primary fluid delivery tube 44a, and provides, during operation, electrical signals proportional to the temperature of the fluid flowing within fluid delivery tube 44a. In this embodiment, the control tables for each type/style of beer stores, for each of a plurality of potential temperature ranges, respective ranges for both pressure and flow rate. During normal operation, controller 18 selectively actuates servomotor 30 and pressure relief valve 40 so as to maintain the pressure of CO₂ gas in gas delivery tube 32 as a function of the temperature detected by temperature transducer 58. Likewise, during normal operation, controller 18 selectively actuates valve 42 to maintain the rate of flow of fluid through fluid delivery tube 44a as a function of the temperature detected by temperature transducer 58. Since the illustrated location of the temperature transducer 58 requires actual fluid flow for accuracy, we suggest that the temperature transducer 58 be attached to the keg 22, either as an integrated element of coupler 20 or as a dongle which can be attached to a suitable outside surface of keg 22 using mechanical means. By taking temperature into consideration, delivery conditions intended by the brewmaster may be more accurately obtained with regard to carbonation and flow rate.

In yet another enhanced embodiment, USB interface 16c is used to provide control information to a refrigeration system adapted to accommodate keg 22 with our dispenser 10 attached (see, e.g., FIG. 2 of Hammond). Alternatively, a conventional heat exchanger (not shown) can be interposed in primary fluid delivery tube 44a upstream of temperature transducer 58, thereby allowing the fluid to be stored in keg 22 at a first temperature but dispensed at a second temperature either cooler or warmer than the first temperature. As will be clear, temperature transducer 58 provides controller 18 temperature feedback, allowing our dispensing system 10 to more precisely adjust, simultaneously, gas delivery pressure, fluid flow rate, and fluid temperature. Now, with the addition of this temperature control loop to our dispensing system 10, the brewmaster's ideal environmental and delivery conditions may be developed for each and every type and style of beer being dispensed.

By way of example, let us assume that a control table for a particular style of ale includes ten (10) range pairs [I, II, . . . , X], each associated with a respective temperature range. During operation, if controller 18 determines, using temperature transducer 58, that the fluid temperature is within, say, temperature range IV, then the range pair associated with temperature range IV will be selected for control of both pressure and flow rate. In an embodiment that incorporates refrigeration capability, the control table will designate a selected one of the temperature ranges as being preferred. During operation, controller 18 will attempt to constrain the temperature to the preferred range. However, even if for any reason the preferred temperature cannot be achieved, controller 18 will still constrain the pressure and flow rates in accordance with the range pair corresponding to selected fluid type and current fluid temperature.

Thus it is apparent that we have provided a dispensing system that selectively controls both the internal pressure and the delivery rate based on real-time conditions within the tank. As is preferred, the dispenser is capable of varying both keg pressure and delivery flow rate in accordance with a set of operating band limits specific to the type of beer being dispensed. Further, the dispenser is responsive to information provided by the consumer regarding the desired conditions of delivery.

What we claim is:

1. A carbonated liquid dispensing system adapted to operatively connect to a first container containing compressed CO₂ gas and to a second container containing a carbonated fluid to be dispensed, the system comprising:
a user interface adapted to enable a user to select a pressure range and a flow rate range;
a gas delivery subsystem adapted to deliver gas from the first container to the second container at a selected pressure;
a fluid delivery subsystem adapted to deliver fluid from the second container to an outlet at a selected flow rate; and
a controller, responsive to the user interface, adapted to:
control the gas delivery subsystem to constrain the selected pressure to within the selected pressure range; and
control the fluid delivery subsystem to constrain the selected flow rate to within the selected flow rate range.

2. The carbonated liquid dispensing system of claim 1 wherein:
said user interface is further adapted to enable a user to select one of a plurality of fluid types; and
said controller is further adapted to:
store, for each of said fluid types, a respective control table comprising a range pair, each pair comprising a pressure range and a flow rate range; and
constrain the gas delivery and fluid delivery subsystems to the pressure and flow rate ranges, respectively, stored in the control table corresponding to the fluid type selected by the user via the user interface.

3. The carbonated liquid dispensing system of claim 2 wherein:
said user interface is further adapted to facilitate electronic download of a supplemental control table; and
said controller is further adapted to store said supplemental control table for selection by said user via the user interface.

4. The carbonated liquid dispensing system of claim 1 wherein:
said user interface is further adapted to facilitate electronic download of a supplemental control table; and
said controller is further adapted to store said supplemental control table for selection by said user via the user interface.

5. A carbonated liquid dispensing system adapted to operatively connect to a first container containing compressed CO₂ gas and to a second container containing a carbonated fluid to be dispensed, the system comprising:
a user interface adapted to enable a user to select a pressure range;
a gas delivery subsystem adapted to deliver gas from the first container to the second container at a selected pressure; and
a controller, responsive to the user interface, adapted to control the gas delivery subsystem to constrain the selected pressure to within the selected pressure range.

6. The carbonated liquid dispensing system of claim 5 wherein:
said user interface is further adapted to enable a user to select one of a plurality of fluid types; and
said controller is further adapted to:
store, for each of said fluid types, a respective control table comprising a pressure range; and
constrain the gas delivery subsystem to the pressure range stored in the control table corresponding to the fluid type selected by the user via the user interface.

7. The carbonated liquid dispensing system of claim 6 wherein:
said user interface is further adapted to facilitate electronic download of a supplemental control table; and
said controller is further adapted to store said supplemental control table for selection by said user via the user interface.

8. The carbonated liquid dispensing system of claim 7 further comprising:
a fluid delivery subsystem adapted to deliver fluid from the second container to an outlet at a selected flow rate; and
wherein
said user interface is further adapted to enable a user to selected a flow rate range;
said control table further comprises a range pair, each pair comprising said pressure range and a flow rate range; and
said controller is further adapted to control said fluid delivery subsystem to constrain said selected flow rate to within said selected flow rate range.

9. The carbonated liquid dispensing system of claim 5 further comprising:
a fluid delivery subsystem adapted selectively to deliver fluid from the second container to an outlet at a selected flow rate; and
wherein
said user interface is further adapted to enable a user to select a flow rate range; and
said controller is further adapted to control said fluid delivery subsystem to constrain said selected flow rate to within said selected flow rate range.

10. The carbonated liquid dispensing system of claim 9 wherein:
said user interface is further adapted to enable a user to select one of a plurality of fluid types; and
said controller is further adapted to:
store, for each of said fluid types, a respective control table comprising a range pair, each range pair comprising said pressure range and said flow rate range; and
constrain the gas delivery and fluid delivery subsystems to the pressure and flow rate ranges, respectively, stored in the control table corresponding to the fluid type selected by the user via the user interface.

11. A carbonated liquid dispensing system adapted to operatively connect to a first container containing compressed CO₂ gas and to a second container containing a carbonated fluid to be dispensed, the system comprising:
a user interface adapted to enable a user to select a pressure range and a flow rate range;
a gas delivery subsystem adapted to deliver gas from the first container to the second container at a selected pressure;
a fluid delivery subsystem adapted to deliver fluid from the second container to an outlet at a selected flow rate;
a temperature control subsystem adapted to determine the temperature of the fluid delivered by the fluid delivery subsystem; and
a controller, responsive to the user interface, adapted to:
control the gas delivery subsystem to constrain the selected pressure to within the selected pressure range as a function of said determined temperature; and
control the fluid delivery subsystem to constrain the selected flow rate to within the selected flow rate range as a function of said determined temperature.

12. The carbonated liquid dispensing system of claim 11 wherein:
said user interface is further adapted to enable a user to select one of a plurality of fluid types; and
said controller is further adapted to:
store, for each of said fluid types, a respective control table comprising a plurality of range pairs, each pair comprising a pressure range and a flow rate range for a selected temperature; and
constrain the gas delivery and fluid delivery subsystems to the pressure and flow rate ranges, respectively, stored in the control table corresponding to the fluid type selected by the user via the user interface as a function of the determined temperature.

13. The carbonated liquid dispensing system of claim 12 wherein:
said user interface is further adapted to facilitate electronic download of a supplemental control table; and
said controller is further adapted to store said supplemental control table for selection by said user via the user interface.

14. The carbonated liquid dispensing system of claim 11 wherein:
said user interface is further adapted to facilitate electronic download of a supplemental control table; and
said controller is further adapted to store said supplemental control table for selection by said user via the user interface.

15. A carbonated liquid dispensing system adapted to operatively connect to a first container containing compressed CO₂ gas and to a second container containing a carbonated fluid to be dispensed, the system comprising:
a user interface adapted to enable a user to select a pressure range;
a gas delivery subsystem adapted to deliver gas from the first container to the second container at a selected pressure;
a temperature control subsystem adapted to determine the temperature of the fluid to be dispensed; and
a controller, responsive to the user interface, adapted to control the gas delivery subsystem to constrain the selected pressure to within the selected pressure range as a function of said determined temperature.

16. The carbonated liquid dispensing system of claim 15 wherein:
said user interface is further adapted to enable a user to select one of a plurality of fluid types; and
said controller is further adapted to:
store, for each of said fluid types, a respective control table comprising a plurality of pressure ranges, each for a respective temperature; and
constrain the gas delivery subsystem to the pressure range stored in the control table corresponding to the fluid type selected by the user via the user interface as a function of the determined temperature.

17. The carbonated liquid dispensing system of claim 16 wherein:
said user interface is further adapted to facilitate electronic download of a supplemental control table; and
said controller is further adapted to store said supplemental control table for selection by said user via the user interface.

18. The carbonated liquid dispensing system of claim 17 further comprising:
a fluid delivery subsystem adapted selectively to deliver fluid from the second container to an outlet at a selected flow rate; and
wherein
said user interface is further adapted to enable a user to select a flow rate range; and
said controller is further adapted to control said fluid delivery subsystem to constrain said selected flow rate to within said selected flow rate range as a function of the determined temperature.

19. The carbonated liquid dispensing system of claim 15 further comprising:
a fluid delivery subsystem adapted selectively to deliver fluid from the second container to an outlet at a selected flow rate; and
wherein
said user interface is further adapted to enable a user to select a flow rate range; and
said controller is further adapted to control said fluid delivery subsystem to constrain said selected flow rate to within said selected flow rate range as a function of the determined temperature.

20. The carbonated liquid dispensing system of claim 19 wherein:
said user interface is further adapted to enable a user to select one of a plurality of fluid types; and
said controller is further adapted to:
store, for each of said fluid types, a respective control table comprising a range pair, each range pair comprising said pressure range and said flow rate range; and
constrain the gas delivery and fluid delivery subsystems to the pressure and flow rate ranges, respectively, stored in the control table corresponding to the fluid type selected by the user via the user interface as a function of the determined temperature.

21. The carbonated liquid dispensing system of claim 20 further characterized as being adapted to operatively connect to a refrigeration subsystem adapted to refrigerate the carbonated fluid, wherein:
each control table further comprises a selected temperature range and a respective range pair; and
the controller is further adapted to constrain the refrigeration subsystem to the temperature range stored in the control table corresponding to the fluid type selected by the user via the user interface.
